(19) United States
(12) Patent Application Publication
(10) Pub. No.: US 2026/0238452 A1
(43) Pub. Date: Aug. 13, 2026

(54) METHOD AND APPARATUS FOR TRANSMISSION WITHIN CELL ACTIVE WINDOW IN MOBILE COMMUNICATIONS

(71) Applicant: MEDIATEK INC., Hsinchu City (TW)

(72) Inventors: Yi-Ju LIAO, Hsinchu City (TW); Wei-De WU, Hsinchu City (TW); Yi-Chia LO, Hsinchu City (TW); Cheng-Hsun LI, Hsinchu City (TW)

(73) Assignee: MEDIATEK INC., Hsinchu City (TW)

(21) Appl. No.: 19/474,663

(22) PCT Filed: Nov. 1, 2024
(86) PCT No.: PCT/CN2024/129417

§ 371 Date: Oct. 10, 2025

Related U.S. Application Data
(60) Provisional application No. 63/595,783, filed on Nov. 3, 2023.

(51) Int. Cl. H04L 5/00

(52) U.S. Cl. CPC H04L 5/0094; H04L 5/0085; H04L 5/0098

(57) ABSTRACT

Various solutions for transmission within cell active window with respect to an apparatus in mobile communications are described. The apparatus may receive a signal indicating a cell active window applicable to the apparatus and a network node. The apparatus may transceive message with the network node within the cell active window.

### CROSS REFERENCE TO RELATED PATENT APPLICATION(S)

The present disclosure is part of a non-provisional application claiming the priority benefit of U.S. Patent Application No. 63/595,783, filed 3 Nov. 2023, the content of which herein being incorporated by reference in its entirety.

### TECHNICAL FIELD

The present disclosure is generally related to mobile communications and, more particularly, to transmission within cell active window with respect to apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR) mobile communications, power saving technologies have been developed. In particular, various features have been introduced to enhance power saving for both the network and the user equipment (UE) across multiple domains, including time, frequency, spatial, and power.

For example, features of discontinuous reception (DRX) assist reduce UE power consumption by allowing the device to periodically enter a sleep state, avoiding continuous monitoring of physical downlink control channel (PDCCH). More specifically, DRX has two modes: idle mode, for paging message monitoring, and connected mode, where the UE wakes up periodically to check for downlink/uplink data. DRX also benefits network efficiency by reducing unnecessary Channel state information (CSI) and sounding reference signal (SRS) transmissions during sleep periods, freeing resources for other UEs.

However, most of the current developed power saving features were not part of the initial network communication design, resulting in increased complexity in both network and UE behavior. In addition, in some cases, the power saving features designed for UE may increase network processing load, while in some cases, the power saving features designed for network may increase UE processing load.

Accordingly, how to design a power saving framework for both network and UE becomes an important issue in the newly developed wireless communication network. Therefore, there is a need to provide proper schemes to design a power saving framework for both network and UE.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to transmission within cell active window with respect to apparatus in mobile communications.

In one aspect, a method may involve an apparatus receiving a signal indicating a cell active window applicable to the apparatus and a network node. The method may further involve the apparatus transceiving message with the network node within the cell active window.

In one aspect, a method may involve an apparatus transmitting a signal indicating a cell active window applicable to the apparatus and at least one user equipment (UE). The method may further involve the apparatus transceiving message with the at least one UE within the cell active window.

In one aspect, an apparatus may comprise a transceiver which, during operation, wirelessly communicates with a wireless network. The apparatus may also comprise a processor communicatively coupled to the transceiver. The processor, during operation, may perform operations comprising receiving, by the transceiver, a signal indicating a cell active window applicable to the apparatus and a network node. The processor may further perform operations comprising transceiving, via the transceiver, message with the network node within the cell active window.

In one aspect, an apparatus may comprise a transceiver which, during operation, wirelessly communicates with a wireless network. The apparatus may also comprise a processor communicatively coupled to the transceiver. The processor, during operation, may perform operations comprising transmitting, via the transceiver, a signal indicating a cell active window applicable to the apparatus and at least one UE. The processor may further perform operations comprising transceiving, via the transceiver, message with the at least one UE within the cell active window.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IOT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a block diagram of an example communication system in accordance with an implementation of the present disclosure.

FIG. 7 is a flowchart of an example process in accordance with an implementation of the present disclosure.

FIG. 8 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to transmission within cell active window with respect to apparatus in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may transmit a signal to a user equipment (UE). The signal may indicate a cell active window applicable to the UE and the network node. The cell active window may be an active period used for both the UE and the network node to transceive message. Therefore, after the UE receives the signal, the network node and the UE may transceive message with each other.

Accordingly, a power saving framework may be applied to both the network node and the UE, ensuring they share the same active period (the cell's active window). This alignment may enable scalable energy consumption, optimizing energy efficiency for both the network node and the UE, without involving significant processing complexity or increasing signaling overhead.

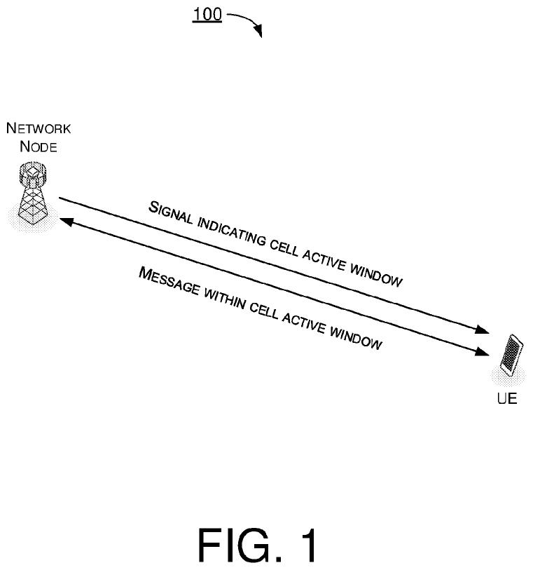

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more than one network nodes.

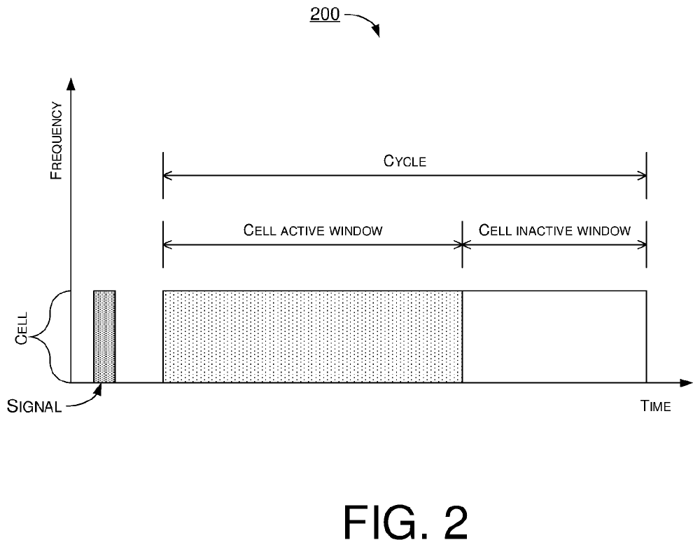

FIG. 2 illustrates an example scenario 200 under schemes in accordance with implementations of the present disclosure. In some embodiments, the network node may transmit a signal to the UE. The signal may indicate a cell active window applicable to the UE and the network node. The cell active window may be an active period of a cycle, and the UE and the network node may transceive message during the active period. In some cases, the cycle may include a cell inactive window which may be an inactive period, and the UE and the network node may not transceive message during the cell inactive window.

Accordingly, after the network node configures the UE by the signal, the network node and the UE may enter an active state within the cell active window (i.e., the active period) and transceive message with each other within the cell active window. In addition, the network node and the UE may enter an inactive state within the cell inactive window (i.e., inactive period) and may not transceive message with each other within the cell inactive window.

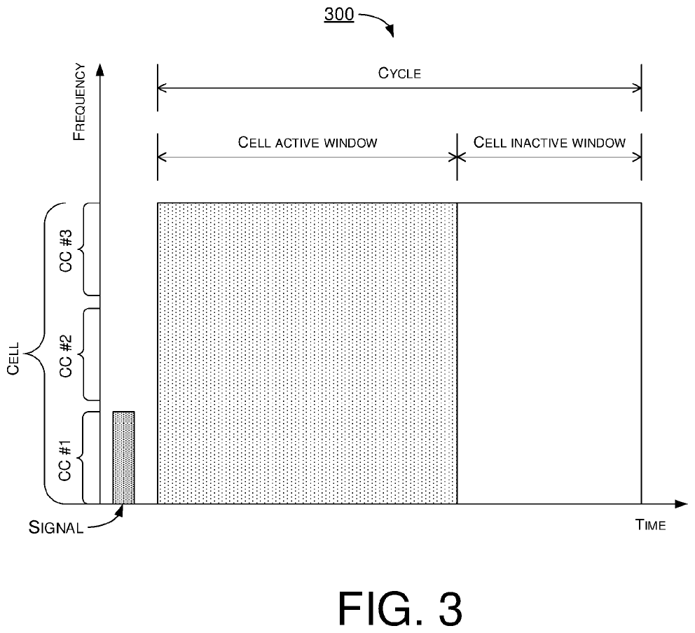

In some implementations, the cell active window of the present disclosure may be cell-wise. In particular, based on FIG. 3 illustrating an example scenario 300 under schemes in accordance with implementations of the present disclosure, the cell active window may be applicable to the network node and the UE across component carriers (CCs) (e.g., CC #1 to #3 in FIG. 3) associated with the cell. In some implementations, the cell active window of the present disclosure may be group-wise. In particular, the cell active window may be applicable to the network node and a group of UE across one or more CCs associated with the cell.

In some implementations, the network node may transmit a downlink (DL) data to the UE within the cell active window. In particular, based on FIG. 2, the UE may monitor physical downlink control channel (PDCCH) within the cell active window. In an event that the network node transmits a PDCCH to the UE within the cell active window, the UE may decode the PDCCH and proceed accordingly. In some implementations, the network node may receive an uplink (UL) data from the UE within the cell active window. In particular, the UE may transmit the UL data (e.g., scheduling request (SR), physical random access channel (PRACH), etc.) to the network node within the cell active window.

In some implementations, the signal may indicate one or more sub-active windows of the cell active window. In particular, each of the one or more sub-active windows may be UE-specific. The network node may transmit a DL data to the UE within at least one specific sub-active window. More specifically, the UE may monitor PDCCH within the at least one specific sub-active window. In an event that the network node transmits a PDCCH to the UE within the at least one specific sub-active window, the UE may decode the PDCCH and proceed accordingly. In some implementations, the network node may receive an UL data from the UE within the cell active window. In particular, the UE may transmit the UL data (e.g., SR, PRACH, etc.) to the network node within the cell active window. In some cases, sub-active window(s) may be selected based on UE-identification (UE-ID), beam (e.g., transmission configuration indication (TCI state)) or UE ramp-up time capability after sleep.

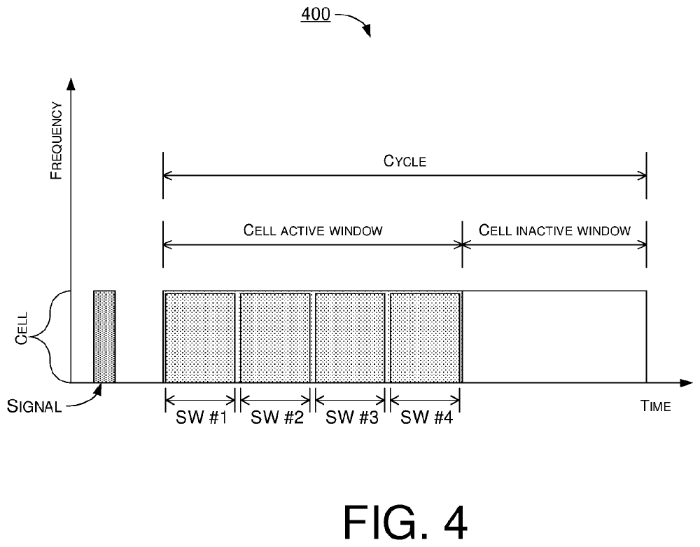

FIG. 4 illustrates an example scenario 400 under schemes in accordance with implementations of the present disclosure. For example, the signal indicates 4 sub-active windows SW #1 to SW #4 of the cell active window. In this example, the sub-active windows SW #1 and #2 are UE-specific for the UE. The network node transmits a PDCCH to the UE within sub-active windows SW #1 and #2. The UE monitors the PDCCH within the sub-active windows SW #1 and #2 and decodes the PDCCH. The UE transmits an UL data (e.g., SR, PRACH, etc.) to the network node within the cell active window while the transmission of the UL data is not restricted to the sub-active windows SW #1 and #2.

In some implementations, the network node may transmit a configuration to the UE for the UE to monitoring the signal. In particular, the configuration may include at least of: (1) a frequency location of the signal; (2) a time location of the signal; (3) a periodicity of the signal; (4) a starting slot offset of the signal; and (5) a payload size of the signal. Accordingly, the UE may monitor the signal based on the configuration. In some cases, the configuration may be included in a radio resource control (RRC) signaling. In some cases, the configuration may be included in a system information block (SIB).

In some cases, in an event that the signal includes a PDCCH, a control resource set (CORESET) and search space set(s) may be configured in the configuration to provide the time location information and the frequency location information.

In some cases, in an event that the signal includes a sequence-based signal, the time location information may include a starting symbol and a duration, and frequency location information may include a starting physical resource block and a number of resource block (RB).

In some cases, the periodicity of the signal may be further configured as a UE-specific monitoring periodicity by a UE-specific RRC signaling. In an event the UE-specific monitoring periodicity is provided, the UE may monitor the signal based on the UE-specific monitoring periodicity. In an event the UE-specific monitoring periodicity is not provided, the UE may monitor the signal based on a default periodicity.

In some implementations, the signal includes at least one of: (1) a wake-up indication associated with the cell active window; (2) a time domain information associated with the cell active window; (3) a spatial domain information associated with the cell active window; and (4) a frequency domain information associated with the cell active window.

In some cases, the wake-up indication may be cell-specific, group-UE-specific or UE-specific, and may indicate the UE whether to wake up for DL control channel (e.g., PDCCH) monitoring during the cell active window.

In some cases, the time domain information may include at least one of: (1) a periodicity of the cell active window; (2) a periodicity of monitoring the signal; (3) an active duration of the cell active window; (4) a starting offset of the cell active window to the signal; (5) a number of sub-active window groups; (6) a sub-active window configuration; (7) an active duration of sub-active window; and (8) a transmission timer. The transmission timer may include an inactivity timer which is triggered after the UE receives UE-specific DL control channel for new transmission or re-transmission. The transmission timer may be a timer which is triggered after the UE transceive data. The cell active window and/or the sub-active window may be extended based on resetting the transmission timer.

In some cases, the spatial domain information may include at least one of: (1) a transceiver unit (TxRU) number; (2) an antenna element number; (2) channel state information (CSI) report configuration; and (3) a number of maximum multi-input multi-output (MIMO) layer.

In some cases, the frequency domain information may include at least one of: (1) a number of active carriers; and (2) bandwidth and center frequency location.

In some implementations, the UE may receive a plurality of signals of the present disclosure. The UE may apply configuration(s) and parameter(s) according to the last received signal. In other words, adaptations to wake-up indications, time domain information, spatial domain information, and frequency domain information may be made based on the most recent received signal.

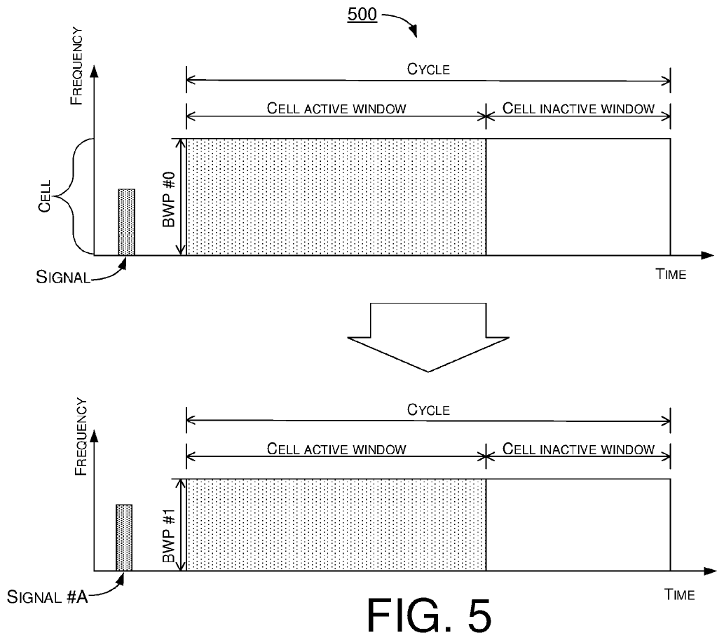

In some implementations, the signal may indicate the UE to change a bandwidth part (BWP). In particular, after receiving the signal, the UE may determine to change BWP from a current BWP to an indicated BWP. FIG. 5 illustrates an example scenario 500 under schemes in accordance with implementations of the present disclosure. For example, the signal #A may indicate a BWP index associated with BWP #1 different from a current BWP index associated with BWP #0. After receiving the signal #A, the UE determines to change BWP from the BWP #0 to the BWP #1. In some cases, when the change of BWP includes frequency domain or spatial domain adaption, a switch gap may be necessary. During the switch gap, the UE may not expect to receive or transmit any signal.

### Illustrative Implementations

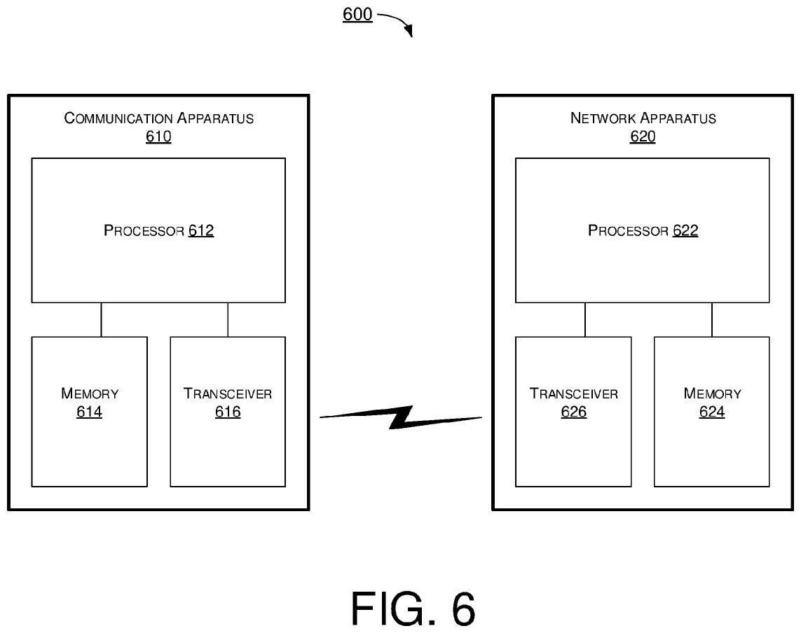

FIG. 6 illustrates an example communication system 600 having an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to transmission within cell active window with respect to UE and network apparatus in mobile communications, including scenarios/schemes described above as well as processes 700 and 800 described below.

Communication apparatus 610 may be a part of an electronic apparatus, which may be a UE such as a portable or mobile apparatus, a wearable apparatus, a wireless communication apparatus or a computing apparatus. For instance, communication apparatus 610 may be implemented in a smartphone, a smartwatch, a personal digital assistant, a digital camera, or a computing equipment such as a tablet computer, a laptop computer or a notebook computer. Communication apparatus 610 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 610 may be implemented in a smart thermostat, a smart fridge, a smart door lock, a wireless speaker or a home control center. Alternatively, communication apparatus 610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 610 may include at least some of those components shown in FIG. 6 such as a processor 612, for example. Communication apparatus 610 may further include one or more other components not pertinent to the proposed scheme of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of a network apparatus, which may be a network node such as a satellite, a base station, a small cell, a router or a gateway. For instance, network apparatus 620 may be implemented in an eNodeB in an LTE network, in a gNB in a 5G/NR, IoT, NB-IoT or IIoT network or in a satellite or base station in a 6G network. Alternatively, network apparatus 620 may be implemented in the form of one or more IC chips such as, for example and without limitation, one or more single-core processors, one or more multi-core processors, or one or more RISC or CISC processors. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including transmission within cell active window in a device (e.g., as represented by communication apparatus 610) and a network (e.g., as represented by network apparatus 620) in accordance with various implementations of the present disclosure.

In some implementations, communication apparatus 610 may also include a transceiver 616 coupled to processor 612 and capable of wirelessly transmitting and receiving data. In other words, processor 612 may transceive the data such as configuration, message, signal, information, indicator, etc. via transceiver 616. In some implementations, communication apparatus 610 may further include a memory 614 coupled to processor 612 and capable of being accessed by processor 612 and storing data therein. In some implementations, network apparatus 620 may also include a transceiver 626 coupled to processor 622 and capable of wirelessly transmitting and receiving data. In other words, processor 622 may transceive the data such as configuration, message, signal, information, indicator, etc. via transceiver 626. In some implementations, network apparatus 620 may further include a memory 624 coupled to processor 622 and capable of being accessed by processor 622 and storing data therein. Accordingly, communication apparatus 610 and network apparatus 620 may wirelessly communicate with each other via transceiver 616 and transceiver 626, respectively. To aid better understanding, the following description of the operations, functionalities and capabilities of each of communication apparatus 610 and network apparatus 620 is provided in the context of a mobile communication environment in which communication apparatus 610 is implemented in or as a communication apparatus or a UE and network apparatus 620 is implemented in or as a network node of a communication network.

In some implementations, each of memory 614 and memory 624 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 614 and memory 624 may include a type of read-only memory (ROM) such as mask ROM, programmable ROM (PROM), erasable programmable ROM (EPROM) and/or electrically erasable programmable ROM (EEPROM). Alternatively, or additionally, each of memory 614 and memory 624 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

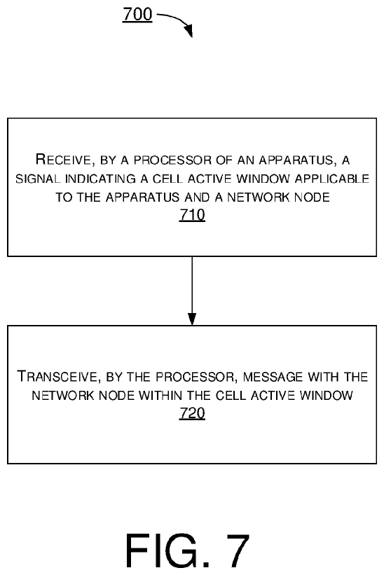

FIG. 7 illustrates an example process 700 in accordance with an implementation of the present disclosure. Process 700 may be an example implementation of above scenarios/schemes, whether partially or completely, with respect to transmission within cell active window of the present disclosure. Process 700 may represent an aspect of implementation of features of communication apparatus 610. Process 700 may include one or more operations, actions, or functions as illustrated by one or more of blocks 710 to 720. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by communication apparatus 610 or any suitable UE or machine type devices. Solely for illustrative purposes and without limitation, process 700 is described below in the context of communication apparatus 610. Process 700 may begin at block 710.

At block 710, process 700 may involve processor 612 of communication apparatus 610 receiving a signal indicating a cell active window applicable to the apparatus and a network node. Process 700 may proceed from block 710 to block 720.

At block 720, process 700 may involve processor 612 of communication apparatus 610 transceiving message with the network node within the cell active window.

In some implementations, the signal may indicate one or more sub-active windows of the cell active window.

In some implementations, process 700 involve processor 612 of communication apparatus 610 receiving a DL data from the network node within at least one of the one or more sub-active windows. Process 700 involve processor 612 of communication apparatus 610 transmitting an UL data to the network node within the cell active window.

In some implementations, process 700 involve processor 612 of communication apparatus 610 receiving a DL data from the network node within the cell active window. Process 700 involve processor 612 of communication apparatus 610 transmitting an UL data to the network node within the cell active window.

In some implementations, the signal may include at least one of: a wake-up indication associated with the cell active window; a time domain information associated with the cell active window; a spatial domain information associated with the cell active window; and a frequency domain information associated with the cell active window.

In some implementations, the time domain information may include at least one of: a periodicity of the cell active window; a periodicity of monitoring the signal; an active duration of the cell active window; a starting offset of the cell active window to the signal; a number of sub-active window groups; a sub-active window configuration; an active duration of sub-active window; and a transmission timer.

In some implementations, process 700 involve processor 612 of communication apparatus 610 determining to change a BWP according to the signal.

In some implementations, the signal may indicates a BWP index different from a current BWP index.

In some implementations, process 700 involve processor 612 of communication apparatus 610 receiving a configuration for monitoring the signal.

In some implementations, the configuration may include at least one of: a frequency location of the signal; a time location of the signal; a periodicity of the signal; a starting slot offset of the signal; and a payload size of the signal.

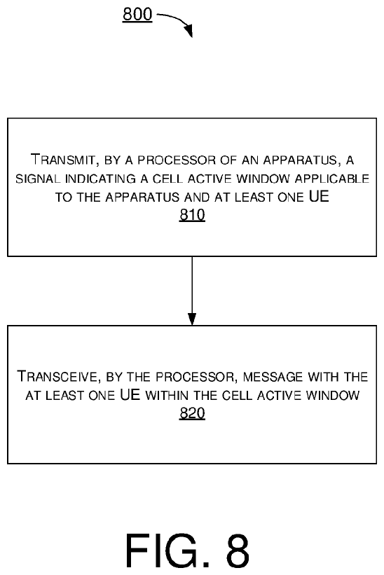

FIG. 8 illustrates an example process 800 in accordance with an implementation of the present disclosure. Process 800 may be an example implementation of above scenarios/schemes, whether partially or completely, with respect to transmission within cell active window of the present disclosure. Process 800 may represent an aspect of implementation of features of network apparatus 620. Process 800 may include one or more operations, actions, or functions as illustrated by one or more of blocks 810 to 820. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by network apparatus 620 or any suitable network device or machine type devices. Solely for illustrative purposes and without limitation, process 800 is described below in the context of network apparatus 620. Process 800 may begin at block 810.

At block 810, process 800 may involve processor 622 of network apparatus 620 transmitting a signal indicating a cell active window applicable to the apparatus and at least one UE. Process 800 may proceed from block 810 to block 820.

At block 820, process 800 may involve processor 622 of network apparatus 620 transceiving message with the at least one UE within the cell active window.

In some implementations, the signal may indicate one or more sub-active windows of the cell active window.

In some implementations, process 800 involve processor 622 of network apparatus 620 transmitting a DL data to the at least one UE within at least one of the one or more sub-active windows. Process 800 involve processor 622 of network apparatus 620 receiving an UL data from the at least one UE within the cell active window.

In some implementations, process 800 involve processor 622 of network apparatus 620 transmitting a DL data to the at least one UE within the cell active window. Process 800 involve processor 622 of network apparatus 620 receiving an UL data from the at least one UE within the cell active window.

In some implementations, the signal may include at least one of: a wake-up indication associated with the cell active window; a time domain information associated with the cell active window; a spatial domain information associated with the cell active window; and a frequency domain information associated with the cell active window.

In some implementations, the time domain information may include at least one of: a periodicity of the cell active window; a periodicity of monitoring the signal; an active duration of the cell active window; a starting offset of the cell active window to the signal; a number of sub-active window groups; a sub-active window configuration; an active duration of sub-active window; and a transmission timer.

In some implementations, the signal may be further for determining to change a BWP.

In some implementations, the signal may indicate a BWP index different from a current BWP index.

In some implementations, process 800 involve processor 622 of network apparatus 620 transmitting a configuration for monitoring the signal.

In some implementations, the configuration may include at least one of: a frequency location of the signal; a time location of the signal; a periodicity of the signal; a starting slot offset of the signal; and a payload size of the signal.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a signal indicating a cell active window applicable to the apparatus and a network node; and
transceiving, by the processor, a message with the network node within the cell active window.

2. The method of claim 1, wherein the signal indicates one or more sub-active windows of the cell active window.

3. The method of claim 2, wherein the step of transceiving the message with the network node within the cell active window further includes at least one of:
receiving, by the processor, a downlink (DL) data from the network node within at least one of the one or more sub-active windows; and
transmitting, by the processor, an uplink (UL) data to the network node within the cell active window.

4. The method of claim 1, wherein the step of transceiving the data with the network node within the cell active window further includes at least one of:
receiving, by the processor, a downlink (DL) data from the network node within the cell active window; and
transmitting, by the processor, an uplink (UL) data to the network node within the cell active window.

5. The method of claim 1, wherein the signal includes at least one of:
a wake-up indication associated with the cell active window;
a time domain information associated with the cell active window;
a spatial domain information associated with the cell active window; and
a frequency domain information associated with the cell active window.

6. The method of claim 5, wherein the time domain information includes at least one of:
a periodicity of the cell active window;
a periodicity of monitoring the signal;
an active duration of the cell active window;
a starting offset of the cell active window to the signal;
a number of sub-active window groups;
a sub-active window configuration;
an active duration of sub-active window; and
a transmission timer.

7. The method of claim 1, further comprising:
determining, by the processor, to change a bandwidth part (BWP) according to the signal.

8. The method of claim 7, wherein the signal indicates a BWP index different from a current BWP index.

9. The method of claim 1, further comprising:
receiving, by the processor, a configuration for monitoring the signal.

10. The method of claim 9, wherein the configuration includes at least one of:
a frequency location of the signal;
a time location of the signal;
a periodicity of the signal;
a starting slot offset of the signal; and
a payload size of the signal.

11. A method, comprising:
transmitting, by a processor of an apparatus, a signal indicating a cell active window applicable to the apparatus and at least one user equipment (UE); and
transceiving, by the processor, a message with the at least one UE within the cell active window.

12. The method of claim 11, wherein the signal indicates one or more sub-active windows of the cell active window.

13. The method of claim 12, wherein the step of transceiving the message with the at least one UE within the cell active window further includes at least one of:
transmitting, by the processor, a downlink (DL) data to the at least one UE within at least one of the one or more sub-active windows; and
receiving, by the processor, an uplink (UL) data from the at least one UE within the cell active window.

14. The method of claim 11, wherein the step of transceiving the message with the network node within the cell active window further includes at least one of:
transmitting, by the processor, a downlink (DL) data to the at least one UE within the cell active window; and
receiving, by the processor, an uplink (UL) data from the at least one UE within the cell active window.

15. The method of claim 11, wherein the signal includes at least one of:
a wake-up indication associated with the cell active window;
a time domain information associated with the cell active window;
a spatial domain information associated with the cell active window; and
a frequency domain information associated with the cell active window.

16. The method of claim 15, wherein the time domain information includes at least one of:
a periodicity of the cell active window;
a periodicity of monitoring the signal;
an active duration of the cell active window;
a starting offset of the cell active window to the signal;
a number of sub-active window groups;
a sub-active window configuration;
an active duration of sub-active window; and
transmission timer.

17. The method of claim 11, wherein the signal is further for determining to change a bandwidth part (BWP).

18. The method of claim 17, wherein the signal indicates a BWP index different from a current BWP index.

19. The method of claim 11, further comprising:
transmitting, by the processor, a configuration for monitoring the signal.

20. The method of claim 19, wherein the configuration includes at least one of:
a frequency location of the signal;
a time location of the signal;
a periodicity of the signal;
a starting slot offset of the signal; and
a payload size of the signal.
